(19) United States
(12) Patent Application Publication
(10) Pub. No.: US 2025/0013363 A1
(43) Pub. Date: Jan. 9, 2025

(54) SYSTEM AND METHODS FOR MANAGING USER ACCESSIBILITY OF WEBPAGES

(71) Applicant: The Toronto-Dominion Bank, Toronto (CA)

(72) Inventors: Samantha Marie Oliveira ESTOESTA, Kitchener (CA); Isaiah Jared ERB, Waterloo (CA); Ronald Allan KIELSTRA, Beamsville (CA); Mathew VOLLICK, London (CA)

(73) Assignee: The Toronto-Dominion Bank, Toronto, ON (CA)

(21) Appl. No.: 18/765,870

(22) Filed: Jul. 8, 2024

Related U.S. Application Data
(60) Provisional application No. 63/512,381, filed on Jul. 7, 2023.

(51) Int. Cl. G06F 3/0489; H04L 67/02

(52) U.S. Cl. CPC G06F 3/0489; H04L 67/02

(57) ABSTRACT

A computer-implemented method is disclosed. The method includes: identifying, in a graphical user interface, a first user interface element and a second user interface element, the first and second user interface elements being of different types and associated with a first group of user interface elements; receiving, via a keyboard, input of a command to trigger a first interaction with both the first and second user interface elements; determining that the first interaction is not defined for one of the first and second user interface elements; and performing a related action associated with the first interaction to the one of the first and second user interface elements.

### CROSS-REFERENCE TO RELATED APPLICATION

The present application claims the benefit of priority to U.S. Provisional Patent Application No. 63/512,381 filed on Jul. 7, 2023, the contents of which are incorporated herein by reference.

### TECHNICAL FIELD

The present application relates to user interfaces and, more particularly, to systems and methods for managing user accessibility of web content.

### BACKGROUND

An accessible graphical user interface (GUI) is an interface that is designed to ensure users with disabilities can access and understand the content presented via the GUI and are able to navigate the GUI to use its features. Accessibility is often not prioritized during early-stage web development and design. Adding accessibility features to individual webpages on a piecemeal basis is inefficient and may lead to incompatibilities with existing web content elements of a website.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for managing user accessibility of a webpage;

FIG. 4 shows, in flowchart form, another example method for managing user accessibility of a webpage;

FIG. 5 shows, in flowchart form, an example method for handling interactions with user interface elements of a graphical user interface;

FIG. 6 shows, in flowchart form, another example method for handling interactions with user interface elements of a graphical user interface;

FIG. 7 shows, in flowchart form, an example use case of the method for handling interactions with user interface elements; and

FIGS. 8A and 8B show example web pages implementing the method for handling interactions with user interface elements.

Like reference numerals are used in the drawings to denote like elements and features.

### DETAILED DESCRIPTION OF VARIOUS EMBODIMENTS

In an aspect, the present disclosure describes a computing system. The computing system includes a processor and a memory coupled to the processor. The memory stores computer-executable instructions that, when executed by the processor, are to cause the processor to: obtain web content of a webpage; determine whether the web content complies with defined first requirements for user accessibility; in response to determining that the web content does not comply with the first requirements: identify non-compliant web content elements of the webpage; and present, via a user interface of a source code editor: indications of first portions of source code for the webpage corresponding to the non-compliant web content elements; and a user interface element representing an action for altering one or more of the non-compliant web content elements.

In some implementations, the instructions, when executed, may further cause the processor to: receive, via a computing device, user input of selection of the user interface element; and in response to receiving the user input, modify the first portions of the source code corresponding to one or more of the non-compliant web content elements.

In some implementations, the instructions, when executed, may further cause the processor to present, via the user interface of the source code editor, indications of recommended modifications to the first portions of the source code corresponding to the non-compliant web content elements.

In some implementations, the recommended modifications may comprise replacement code for the first portions of the source code corresponding to the non-compliant web content elements.

In some implementations, obtaining the web content may include performing a scan of the webpage to obtain at least one of text, visual, or auditory content associated with the webpage.

In some implementations, the first requirements may comprise a set of testable content criteria and determining whether the web content complies with the first requirements may include determining whether the web content satisfies at least one of the content criteria.

In some implementations, determining whether the web content complies with the first requirements may include determining whether the web content satisfies all of the content criteria.

In some implementations, the indications may comprise graphical indicators for distinguishing the first portions from other portions of the source code for the webpage.

In some implementations, the instructions, when executed, may further cause the processor to retrieve current requirements for user accessibility in connection with the webpage and compliance of the web content with the first requirements may be assessed using the current requirements.

In some implementations, the instructions, when executed, may further cause the processor to store the retrieved current requirements for user accessibility in the memory.

In another aspect, the present disclosure describes a computer-implemented method. The method includes: obtaining web content of a webpage; determining whether the web content complies with defined first requirements for user accessibility; in response to determining that the web content does not comply with the first requirements: identifying non-compliant web content elements of the webpage; and presenting, via a user interface of a source code editor, indications of first portions of source code for the webpage corresponding to the non-compliant web content elements.

In another aspect, the present disclosure describes a computing system. The computing system includes a processor and a memory coupled to the processor. The memory stores computer-executable instructions that, when executed by the processor, are to cause the processor to: identify, in a graphical user interface, a first user interface element and a second user interface element, the first and second user interface elements being of different types and associated with a first group of user interface elements; receive, via a keyboard, input of a command to trigger a first interaction with both the first and second user interface elements; determine that the first interaction is not defined for one of the first and second user interface elements; and perform a related action associated with the first interaction to the one of the first and second user interface elements.

In some implementations, the first and second user interface elements may be input controls corresponding to items of a defined set.

In some implementations, each of the first and second user interface elements may be one of a radio button or a checkbox.

In some implementations, the first interaction may comprise a deselect action for clearing selected items and the related action may comprise a clear action for cancelling selection from a radio button.

In some implementations, performing the related action may include determining the related action based on a mapping between user interface interactions and one or more related actions.

In another aspect, the present disclosure describes a computer-implemented method. The method includes: identifying, in a graphical user interface, a first user interface element and a second user interface element, the first and second user interface elements being of different types and associated with a first group of user interface elements; receiving, via a keyboard, input of a command to trigger a first interaction with both the first and second user interface elements; determining that the first interaction is not defined for one of the first and second user interface elements; and performing a related action associated with the first interaction to the one of the first and second user interface elements.

In another aspect, the present disclosure describes a non-transitory, computer-readable medium storing instructions that, when executed by a processor, configure the processor to perform any of the methods disclosed herein.

A developer tool that facilitates code development for web accessibility is disclosed. The developer tool is configured to obtain web content of a webpage and assess the user accessibility of web content elements that are included in the webpage. More particularly, the developer tool may determine whether the web content elements, as displayable to users of the webpage, comply with defined requirements for user accessibility. The requirements may, for example, comprise guidelines, such as the Web Content Accessibility Guidelines (WCAG), for making web content accessible to end users. If the web content elements do not comply with all or a subset of the requirements, the developer tool enables the developer to take certain actions for remedying the non-compliance. By way of example, the developer tool may facilitate modifying the source code for the webpage to fix identifiable accessibility issues with one or more of the web content elements of the webpage.

In at least some implementations, the developer tool identifies non-compliant web content elements of a webpage and presents the developer with options for resolving any defects in the source code causing the non-compliance. Specifically, the developer tool may present, via a user interface of a source code editor, indications of portions of the source code that correspond to non-compliant web content elements and a selectable option for a single-action resolution of the source code defects. For example, the developer tool may graphically represent portions of the source code corresponding to one or more non-compliant web content elements of a webpage. The developer tool may also be configured to display a user interface element representing an action or operation for modifying the source code portions and/or altering one or more of the non-compliant web content elements.

Additionally, or alternatively, the developer tool may provide recommendations for modifying or replacing the source code portions such that the resulting web content elements comply with defined requirements for user accessibility. For example, the recommended modifications may include replacement code for portions of the source code corresponding to the non-compliant web content elements.

A method for handling interactions with user interface elements is also disclosed. The disclosed method enables applying a single keyboard-initiated action to two or more different types of user interface elements. A user input, received via a keyboard, for initiating an interaction with a user interface element may be applied to a plurality of different user interface elements of a same group. By way of example, “deselect all” is a defined interaction for checkboxes that serves to clear selections from all checkboxes in a list. The “deselect all” action is typically not defined for a radio button, since radio buttons enforce selection, i.e., once a radio button has been selected, there is no option to “deselect” it. According to the disclosed method, when both a checkbox and a radio button are shown in a list/grouping of user interface elements, a “deselect all” command may be applied to the checkbox and the radio button in a similar manner such that the interaction leads to effectively the same result of clearing all selections. In particular, the “deselect all” command may reset the radio button such that any previous selection of the radio button is cleared, i.e., the selection is no longer enforced.

A CSS widget for augmenting display of web properties is also disclosed. The proposed widget may be formalized as a CSS switcher, rather than a JavaScript-based tool. With JavaScript-based tools, those using screen readers may be required to choose between using their assistive technologies or utilizing selected display preferences. The proposed widget allows for those using assistive technologies to still fully utilize the display preferences that are available through the widget.

The display preferences may include one or more of: reading guide; stop animations; change font size; highlight title; highlight links; easy-to-read font; dark contrast; light contrast; high contrast; high saturation; low saturation; monochrome; etc. Users can customize their display preferences using as many or as few of the preferences in the widget. The display preferences may be page-specific such that if the user leaves a web page and then returns to it, the settings will automatically match the selected preferences until they are explicitly reset by the user.

The proposed widget may embed a user interface element for accessing the widget in a navigation menu associated with a web page. Upon selection of the user interface element, a display preferences menu may be presented as a primary visual focus on the web page. In some implementations, the widget may be provided as part of an accessibility extension/plug-in for a web browser such that web pages that are visited using the web browser can present similar functionality of page display customizations.

The plug-in may receive a request to enable accessibility mode for a graphical user interface. In response to receiving the request, the plug-in may identify a navigation menu associated with a current web page displayed on the graphical user interface. For example, the plug-in may identify, based on source code of the web page, a navigation bar element for the web page. The source code may then be modified to add a menu item corresponding to an accessibility settings manager, such as a display preferences menu, to the navigation menu.

When the new menu item of the navigation menu is selected, a display preferences menu may be displayed in the graphical user interface as a modal window overlaying the web page. The modal window may be centrally disposed on the web page to indicate it as a new primary visual focus. In some implementations, other techniques, such as greying out the web page, may be employed to emphasize the modal window as the visual focus.

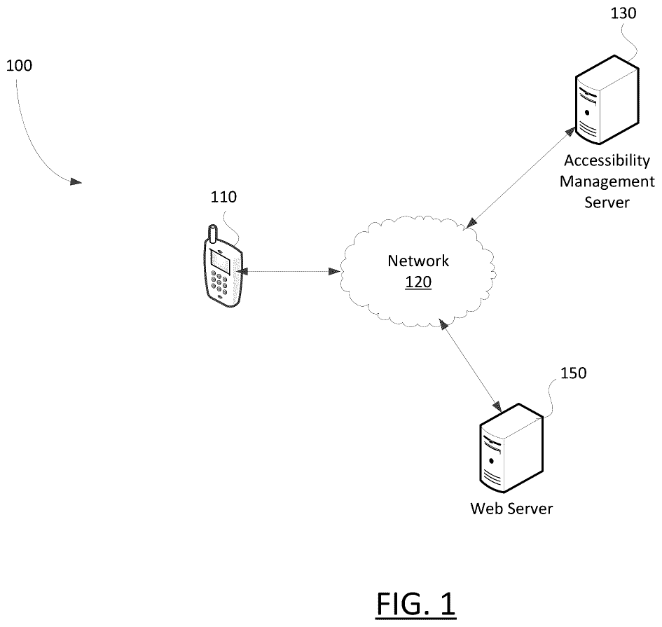

FIG. 1 is a schematic diagram illustrating an operating environment of an example embodiment. In particular, FIG. 1 illustrates exemplary components of a system 100 for monitoring, modifying, or otherwise managing user accessibility of webpages.

As illustrated, an accessibility management server 130 and client devices 110 communicate via the network 120. The client device 110 is a computing device. The client device 110 may take a variety of forms such as, for example, a mobile communication device which may be a smartphone, a tablet computer, a wearable computer such as a head-mounted display or smartwatch, a laptop or desktop computer, or a computing device of another type.

The accessibility management server 130 is a computing system that is configured to process web content of webpages and assess the user accessibility of the web content. In at least some implementations, the accessibility management server 130 retrieves (or accesses) a set of defined requirements for user accessibility and evaluates web content elements against the set of requirements. In particular, the accessibility management server 130 may assess whether all or a subset of the web content elements of a webpage comply with certain user accessibility requirements. The user accessibility requirements may, for example, comprise a set of testable web content criteria, and the accessibility management server 130 may determine whether the web content satisfies all or at least a threshold number of the web content criteria.

In at least some implementations, the accessibility management server 130 may perform testing of web content elements for compliance with user accessibility requirements. For example, the accessibility management server 130 may be configured to test for and detect the presence of certain web content elements, such as text alternatives, captions, alternatives for time-based media, audio descriptions, images of text, color, page title, metadata, etc., in a webpage. More generally, the accessibility management server 130 may implement modules, applications, etc. to programmatically test the operability, understandability, and compatibility of webpages.

Additionally, or alternatively, the accessibility management server 130 may generate recommendations for modifying the web content and/or webpage source code. In some implementations, the accessibility management server 130 may comprise a back-end for a developer tool, such as an integrated development environment (IDE), for code development. The accessibility management server 130 may be configured to present information in a code development environment that supports developing webpages that are user accessible. For example, upon detecting web content elements that do not comply with requirements for user accessibility, the accessibility management server 130 may present indications of portions of the source code for the webpage corresponding to the non-compliant web content elements.

The system 100 includes one or more web servers 150. A web server 150 is a computing system on which web-based services or applications can be run. In particular, the web server 150 may host one or more web services (or service applications). The web server 150 accepts requests via a network protocol (e.g., Hypertext Transfer Protocol). For example, a client's user agent, such as a web browser, may request for a specific resource using HTTP and the web server 150 may respond by providing content associated with the requested resource or an error message to the client. The content may include pre-existing files that are available to the web server 150 (e.g., static content), or it can be generated by another program that communicates with the web server 150 (e.g., dynamic content). The web server 150 may also be configured to receive and store resources that are sent by clients. The web server 150 may comprise a single computer, an embedded system, or a collection of computers.

The client devices 110, the accessibility management server 130, and the web servers 150, may be in geographically disparate locations. Put differently, the client devices 110 may be remote from the accessibility management server 130 and the web servers 150. As explained herein, the client device 110, the accessibility management server 130, and the web servers 150 are computing systems.

The network 120 is a computer network. In some implementations, the network 120 may be an internetwork such as may be formed of one or more interconnected computer networks. For example, the network 120 may be or may include an Ethernet network, an asynchronous transfer mode (ATM) network, a wireless network, or the like.

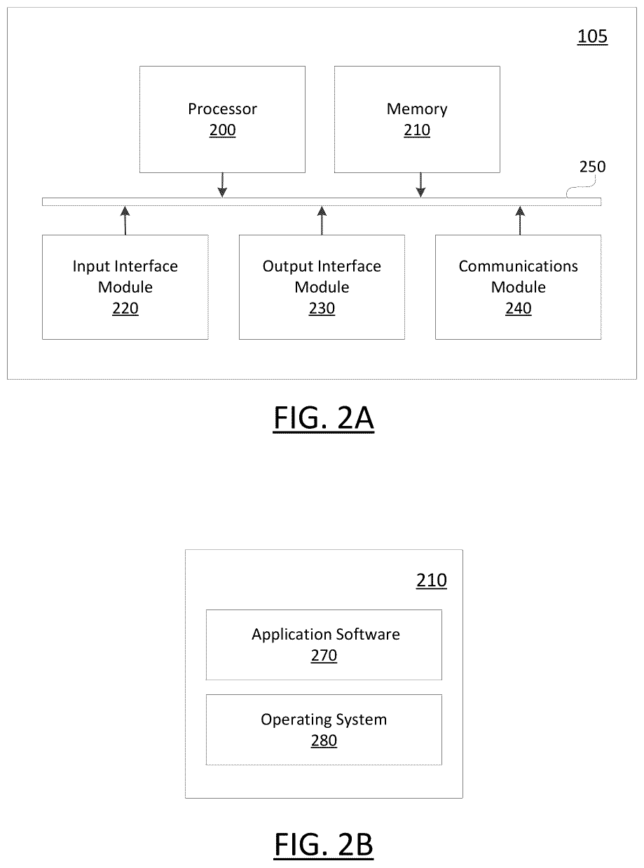

FIG. 2A is a high-level operation diagram of an example computing device 105. In at least some implementations, the example computing device 105 may be exemplary of one or more of: the client devices 110, the accessibility management server 130, and the web servers 150. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280. The application software 270 adapts the example computing device 105, in combination with the operating system 280, to operate as a device performing a particular function. The operating system 280 is software. The operating system 280 allows the application software 270 to access the processor 200, the memory 210, the input interface module 220, the output interface module 230 and the communications module 240. The operating system 280 may be, for example, Apple iOS™, Google Android™, Linux™, Microsoft Windows™, or the like.

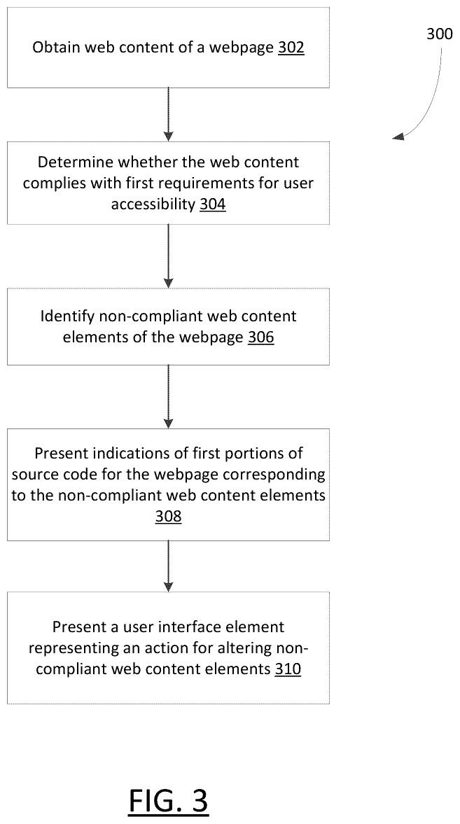

Reference is now made to FIG. 3, which shows, in flowchart form, an example method 300 for managing user accessibility of webpages. The operations of method 300 may be performed by a computing system that is configured to provide a development environment, such as a web IDE, for web development. In particular, the operations of method 300 may be included in a process for providing a user interface of a web development environment that facilitates compliance with user accessibility requirements. The method 300 may be implemented by a computing system, such as the accessibility management server 130 of FIG. 1, that is configured to process web content of webpages to assess user accessibility.

In operation 302, the computing system obtains web content of a webpage. In at least some implementations, the computing system identifies the web content elements within the webpage which may include text, visual (e.g., images, videos, etc.), and/or auditory content elements as well as user interface elements (e.g., input controls, navigational, etc.). By way of example, the computing system may perform a scan of the webpage and/or a source document (i.e., source code file) associated with the webpage to identify and retrieve a list of web content elements. As part of operation 302, the computing system may obtain only those web content elements that are made available for users of the webpage to interact with. That is, the web content obtained by the computing system may comprise components of the webpage that can be directly accessed (e.g., perceived, operated, etc.) by webpage users.

In some implementations, operation 302 may be performed in real-time as a developer generates the source code for a webpage using a web IDE. That is, the current content of the webpage may be monitored/scanned throughout development of the webpage. The web content of the webpage corresponds to the source code that is inputted by the developer using the web IDE. By implementing the method 300, the computing system provides a web IDE that assesses the current web content and provides feedback regarding user accessibility compliance in real-time during development.

In operation 304, the computing system determines whether the web content complies with defined first requirements for user accessibility. More particularly, the computing system assesses whether the web content elements of the webpage comply, individually or collectively, with the first requirements. The first requirements may comprise a set of testable criteria, such as success criteria relating to the web content. For example, the first requirements may include or be part of a set of web accessibility guidelines, such as the Web Content Accessibility Guidelines (WCAG), that have testable criteria for making web content accessible. For each success criterion, the web accessibility guidelines may specify a technique or combination of techniques that are deemed sufficient for meeting the success criterion. The computing system may determine whether the web content satisfies at least one of defined content criteria. In some implementations, the computing system may determine whether the web content satisfies all of the content criteria. For example, tests may be performed on the web content elements of the webpage to determine if they successfully satisfy content criteria defined by the first requirements.

The first requirements may include content criteria that can be categorized according to various principles of accessibility. Such principles may include, among others, perceivability, operability, understandability, and robustness. For example, the first requirements may stipulate that: information and user interface components be presentable to users in ways they can perceive; user interface components and navigation must be operable; information and the operation of user interface must be understandable; and content must be robust enough that it can be interpreted reliably by a wide variety of user agents including assistive technologies.

As the guidelines/criteria for user accessibility may evolve over time, the first requirements may be dynamically determined. In particular, the computing system may be configured to retrieve current requirements for user accessibility in connection with the webpage. For example, the computing system may determine a type (or types) associated with the webpage and retrieve current accessibility requirements for said webpage type(s). As another example, the computing system may scan the current web content elements of the webpage and retrieve relevant accessibility requirements for said content elements. The current accessibility requirements may be retrieved, for example, from a data store that is dynamically maintained and updated. The computing system may subsequently assess compliance or non-compliance of the web content with the current accessibility requirements for the webpage.

The evaluation of user accessibility may proceed based on testing of success criteria associated with the first requirements. The web content elements of the webpage can be assessed against all (or a subset of) relevant success criteria, and the computing system may determine whether the web content elements satisfy the criteria. For example, the computing system may determine properties of user interface elements of the webpage and assess whether said properties satisfy the criteria. In at least some implementations, the computing system may determine whether one or more techniques stipulated by the web accessibility guidelines as being sufficient for meeting the success criteria have been implemented on the webpage. For each of one or more criteria, the web accessibility guidelines may specify at least one technique that, if implemented, would be sufficient to satisfy the criterion. The computing system may monitor for the implementation of one more such techniques in addition to, or in place of, directly comparing properties of the web content elements against success criteria.

If at least one web content element of the webpage does not satisfy a relevant success criterion, the web content may be determined to not comply with the first requirements. In response to such determination, the computing system identifies the non-compliant web content elements of the webpage, in operation 306. In particular, the web content elements that do not satisfy their associated success criteria are identified. These web content elements may, for example, include the content elements of the webpage that failed the testing of success criteria associated with the web accessibility guidelines.

The non-compliant portions of source code for the webpage corresponding to the non-compliant web content elements are then identified. In some implementations, the computing system determines, or obtains, a mapping of source code portions to web content elements, and the non-compliant portions are identified based on the mapping. In operation 308, the computing system presents, via a user interface of a source code editor, indications of the non-compliant portions of the source code. The indications may comprise, for example, graphical indicators for distinguishing the non-compliant portions from other portions of the source code for the webpage. For example, the non-compliant source code portions may be highlighted, underlined, or otherwise distinguished from the other source code portions. Additionally, or alternatively, the indications may include text describing the non-compliant portions of the source code and reasons for non-compliance with the first requirements. For example, the indications may specify a requirement or content criterion from the first requirements that a particular web content element does not satisfy. As another example, the indications may include a description of a technique or combination of techniques that would be sufficient for satisfying the one or more failed criteria.

In at least some implementations, the computing system further presents, via the user interface of the source code editor, a user interface element representing at least one action for altering the non-compliant web content elements, in operation 310. The user interface element may, for example, comprise an input control (e.g., a button, a toggle, etc.) for triggering changes to the non-compliant web content elements. The changes may include, for example, modifications to the source code in order to implement one or more techniques sufficient for satisfying the failed criteria. Additionally, or alternatively, the changes may include modifications to the source code that are either specified by the developer or derived based on developer preferences with respect to user accessibility requirements. The computing system may receive, via a user device, user input of selection of the user interface element. In response to receiving the user input, the computing system may automatically modify (or cause to be modified) the non-compliant portions of the source code corresponding to one or more of the non-compliant web content elements.

More generally, the computing system may present, via the user interface of a source code editor, a selectable option for a single-action resolution of the source code defects resulting in non-compliance with user accessibility requirements. The option may be implemented as a user interface element displayed on the graphical user interface, or otherwise a different mechanism for triggering a comprehensive modification of the source code to resolve all or a subset of the identified defects leading to non-compliance. This option enables a developer to conveniently resolve issues with the source code relating to user accessibility using a single control function, rather than through a series of manual modifications to the source code.

In at least some implementations, the computing system may present, via the user interface of the source code editor, indications of recommended modifications to the non-compliant portions of the source code corresponding to the non-compliant web content elements. The recommended modifications may, for example, comprise replacement code for at least some of the non-compliant portions of the source code corresponding to the non-compliant web content elements. The computing system may determine the replacement code based on generating code for implementing a technique (or combination of techniques) that are sufficient to satisfy the failed content criteria. In this way, the recommended modifications may bring the source code of the webpage into alignment with techniques that are deemed sufficient to meet success criteria associated with the web accessibility guidelines.

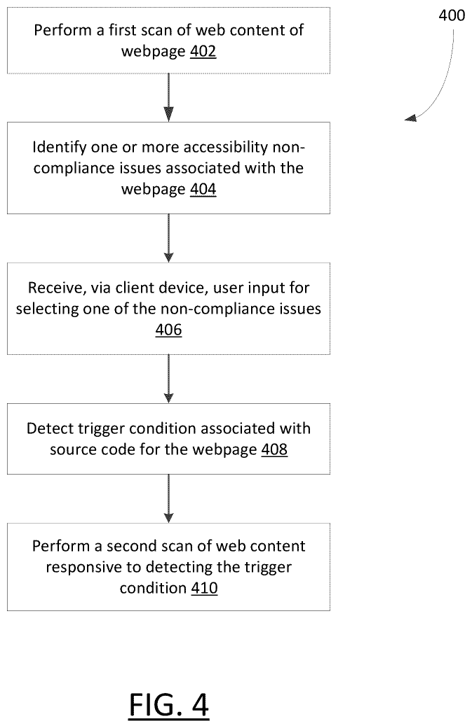

Reference is now made to FIG. 4, which shows, in flowchart form, another example method 400 for managing user accessibility of webpages. The operations of method 400 may be performed by a computing system that is configured to provide a development environment, such as a web IDE, for web development. In particular, the operations of method 400 may be included in a process for providing a user interface of a web development environment that facilitates compliance with user accessibility requirements. The method 400 may be implemented by a computing system, such as the accessibility management server 130 of FIG. 1, that is configured to process web content of webpages to assess user accessibility. The operations of method 400 may be performed in addition to, or as alternatives of, one or more of the operations of method 300.

The computing system obtains web content of a webpage. In at least some implementations, the computing system identifies web content elements of the webpage which may include, among others, text, visual (e.g., images, videos, etc.), and/or auditory content, and user interface elements (e.g., input controls). In operation 402, the computing system performs a first scan of the webpage and/or a source document, such as a source code file, associated with the webpage to retrieve a list of web content elements. As part of operation 402, the computing system may obtain only those web content elements that are made available for user of the webpage to interact with. That is, the web content obtained by the computing system may comprise components of the webpage that can be directly accessed (e.g., perceived, operated, etc.) by webpage users. In at least some implementations, the web content is obtained in real-time throughout the development of the webpage. In particular, the current web content elements that are placed within the webpage may be determined and retrieved based on the source code of the webpage during development.

The computing system determines whether the web content complies with defined first requirements for user accessibility and in operation 404, the computing system identifies one or more user accessibility non-compliance issues associated with the webpage. More particularly, the computing system assesses whether the web content elements of the webpage comply, individually or collectively, with the first requirements. The first requirements may comprise a set of testable criteria, such as success criteria relating to the web content. For example, the first requirements may include or be part of a set of web accessibility guidelines, such as the Web Content Accessibility Guidelines (WCAG), that have testable criteria for making web content accessible. For each success criterion, the web accessibility guidelines may specify a technique or combination of techniques that are deemed sufficient for meeting the success criterion. The computing system may determine whether the web content satisfies at least one of defined content criteria. In some implementations, the computing system may determine whether the web content satisfies all of the content criteria. For example, tests may be performed on the web content elements of the webpage to determine if they successfully satisfy content criteria defined by the first requirements.

As the guidelines/criteria for user accessibility may evolve over time, the first requirements may be dynamically determined. In particular, the computing system may be configured to retrieve current requirements for user accessibility in connection with the webpage. For example, the computing system may determine a type (or types) associated with the webpage and retrieve current accessibility requirements for said webpage type(s). The current accessibility requirements may be retrieved, for example, from a data store that is dynamically maintained and updated. The computing system may subsequently assess compliance or non-compliance of the web content with the current accessibility requirements for the webpage.

The evaluation of user accessibility may proceed based on testing of success criteria associated with the first requirements. The web content elements of the webpage can be assessed against all (or a subset of) relevant success criteria, and the computing system may determine whether the web content elements satisfy the criteria. In at least some implementations, the computing system may detect that one or more techniques stipulated by the web accessibility guidelines as being sufficient for meeting the success criteria are implemented on the webpage.

If at least one web content element of the webpage does not satisfy a relevant success criterion, the web content may be determined to not comply with the first requirements. In response to such determination, the computing system identifies the accessibility non-compliance issues for the webpage. In particular, the web content elements that do not satisfy their associated success criteria are identified. These web content elements may, for example, include the elements of the webpage that failed the testing of success criteria associated with the web accessibility guidelines.

The computing system presents, via the user interface of the source code editor, a list of the identified non-compliance issues associated with the webpage. The list may comprise a plurality of selectable items that can be individually accessed by a developer. Each said item may correspond to a respective non-compliance issue which may, in some implementations, be identified as an error associated with the source code of the webpage. In operation 406, the computing system receives, via a client computing device, user input for selecting one of the listed non-compliance issues. Each listed item is associated with a respective non-compliance issue and includes detailed information about the issue such as, for example, the relevant accessibility requirement, one or more associated success criteria, and reason(s) for the non-compliance. The item may also include guidance on fixing the non-compliance issue. In particular, when a listed item is selected, the item may provide, via the client computing device, guidance on which elements and/or portions of source code to modify in order to bring the associated web content element(s) into compliance with the user accessibility requirements. The guidance may, for example, include replacement code or other forms of recommended modifications to the source code of the webpage.

In some implementations, the computing system may present, via the user interface of a source code editor, a selectable option for a single-action resolution of the source code defects resulting in non-compliance with user accessibility requirements. The option may be implemented as a user interface element displayed on the graphical user interface, or otherwise a different mechanism for triggering a comprehensive modification of the source code to resolve all or a subset of the identified defects leading to non-compliance. This option enables a developer to conveniently address issues with the source code using a single control function, rather than through a series of manual modifications to the source code.

In operation 408, the computing system detects a trigger condition associated with source code for the webpage. For example, the computing system may determine that portions of the source code have changed, either automatically or via manual edit, following user selection of the non-compliance issue listing. The change in source code may, for example, be the result of developer selection of a single control function for modifying the source code, as described above, or manual edit by the developer. A second scan (i.e., subsequent to the first scan) of the web content of the webpage can then be initiated responsive to detecting the trigger condition, in operation 410. The second scan represents a further scan of the webpage content for determining whether the detected changes to the source code resolved the non-compliance issue. Based on the results of the second scan, the computing system determines whether the modified source code brings the impugned web content elements associated with the non-compliance issue into alignment with the user accessibility requirements for the webpage. In this way, the webpage/source code file can be iteratively scanned after each set of modifications in order to fix non-compliance issues.

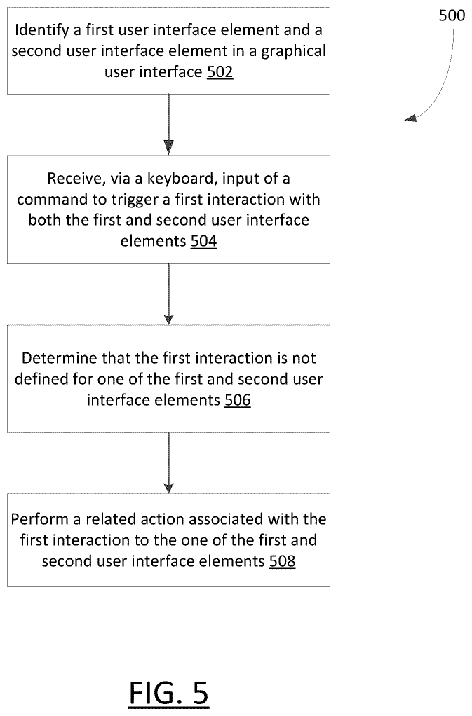

Reference is now made to FIG. 5, which shows, in flowchart form, an example method 500 for handling interactions with user interface elements of a graphical user interface. The operations of method 500 may be performed by a computing system that is configured to provide a development environment, such as a web IDE, for web development. In particular, the operations of method 500 may be included in a process for providing a user interface of a web development environment that facilitates compliance with user accessibility requirements. The method 500 may be implemented by a computing system, such as the accessibility management server 130 of FIG. 1, that is configured to process web content of webpages to assess user accessibility. The operations of method 500 may be performed in addition to, or as alternatives of, one or more of the operations of methods 300 and 400.

In operation 502, the computing system identifies a first user interface element and a second user interface element in a graphical user interface, where the first and second user interface elements are of different types and are associated with a same group of user interface elements. For example, the first and second user interface elements may be input controls corresponding to items of a defined set or grouping of components, such as control components. The first user interface element may be a radio button corresponding to a first item in a list and the second user interface element may be a checkbox corresponding to a second item in the same list. As another example, the first and second user interface elements may be input controls that are contained within a same container within the graphical user interface.

The computing system receives, via a keyboard, input of a command to trigger a first interaction with both the first and second user interface elements, in operation 504. The input may comprise selection of a user interface element, text input, or the like, for indicating a user's desired interaction. The first interaction may, for example, be a “deselect” action for signaling a desire to clear all currently selected items of a set of items.

In operation 506, the computing system determines that the first interaction is not defined for one of the first and second user interface elements. A “deselect” action is typically not defined for a radio button, as it goes against the user interface element's design guidance. The computing system then determines a related action associated with the first interaction. A related action refers to an undefined action for a user interface element which may be performed and which results in a similar effect as a defined action for a different user interface element. For example, for the “deselect” action for interacting with a checkbox, a related action for a radio button may be a “clear” action for cancelling a selection from the radio button. The related action is then performed on the one of the first and second user interface elements, in operation 508.

In at least some implementations, the computing system may determine a related action for a user interface element based on a mapping between user interface interactions and one or more related actions. A mapping may be generated between defined interactions for various user interface elements (e.g., “deselect” for checkbox, etc.) and one or more related actions which may be performed on different user interface elements for which the same interactions are not expressly defined. The mapping may associate the various interactions with related actions that have the same or similar effect on the different user interface elements. The computing system may use the mapping for determining a related action only when the command to initiate an interaction with one or more user interface elements is received via a keyboard. In particular, a related action may not be determined or performed on a user interface element when the command to initiate an interaction is received via a different input device (e.g., mouse, microphone, etc.).

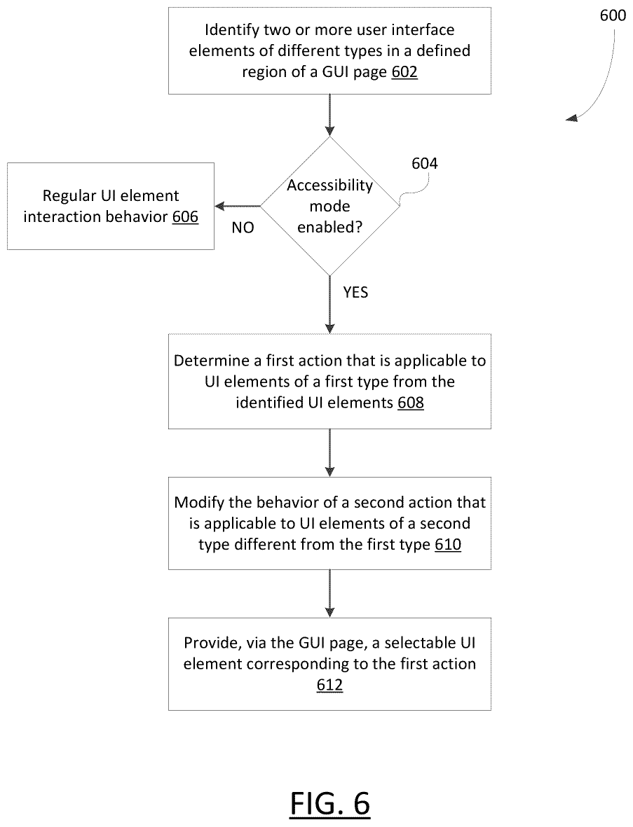

Reference is now made to FIG. 6, which shows, in flowchart form, an example method 600 for handling interactions with user interface elements of a graphical user interface. The operations of method 600 may be performed by a computing system that is configured to provide a development environment, such as a web IDE, for web development. In particular, the operations of method 600 may be included in a process for providing a user interface of a web development environment that facilitates compliance with user accessibility requirements. The method 600 may be implemented by a computing system, such as the accessibility management server 130 of FIG. 1, that is configured to process web content of webpages to assess user accessibility. The operations of method 600 may be performed in addition to, or as alternatives of, one or more of the operations of methods 300, 400, and 500.

In operation 602, the computing system identifies two or more user interface elements of different types within a page of a graphical user interface. For example, the user interface elements may be components that are located in a same defined region or container. The defined region may comprise a grouping of web content elements. Additionally, or alternatively, the defined region may be a particular location within the GUI page. The UI elements may be different types of informational controls, navigational controls, or input controls.

The computing system then determines whether accessibility mode is enabled for the webpage (operation 604). If accessibility mode is not enabled, the computing system processes interactions with user interface elements according to regular UI element interaction behavior (operation 606). That is, no changes to the expected behavior of UI input controls may be implemented if accessibility mode is not enabled.

On the other hand, if accessibility mode is enabled, the computing system determines a first action that is applicable to UI elements of a first type from the identified UI elements in the defined region, in operation 608. The first action is one that has defined behavior for UI elements of the first type. In particular, the first action is one that is defined and that results in predictable behavior when the action is initiated using a UI element of the first type.

In operation 610, the computing system modifies the behavior of a second action that is applicable to UI elements of a second type different from the first type. The second action is one that is defined for UI element of the second type. The defined behavior of the second action is modified such that the first action is applicable to all UI elements of the second type. Specifically, the second action is replaced by the first action or an alternate version of the first action that is suitable for UI elements of the second type. In this way, the first action is made to be compatible with UI elements of the second type and the second action is supplanted, producing a single-action that has predictably similar behavior across different types of UI elements.

In operation 612, the computing system provides, via the GUI page, a selectable UI element corresponding to the first action. The selection of the UI element can apply the first action (or its equivalent) to both the UI elements of the first type and the UI elements of the second type.

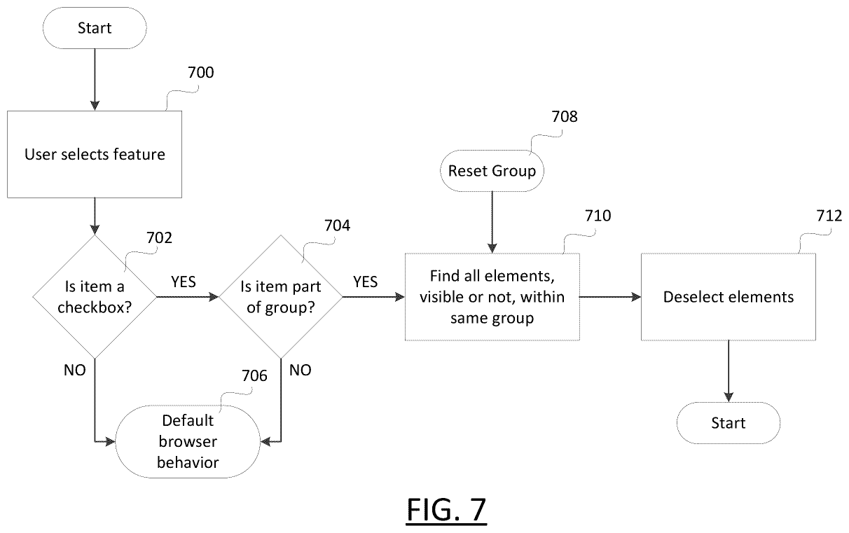

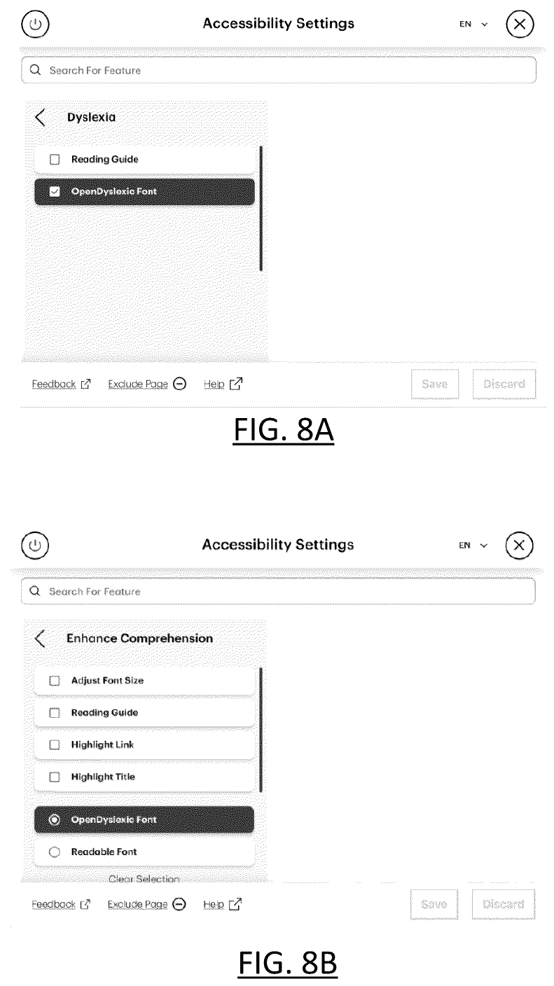

Reference is now made to FIG. 7, which shows, in flowchart form, an example use case of the method for handling interactions with user interface elements. A website user may select a feature from a list of features by indicating the selection using a user interface element (operation 700). If the user interface element is not a checkbox, the selection may be handled using default browser behavior (operation 706). If, on the other hand, the user interface element is a checkbox (operation 702), the computing system determines whether the selected item is part of a group of features (operation 704). In the example of FIGS. 8A and 8B, the selected feature “OpenDyslexic Font” belongs to a “Fonts” feature group that also includes, at least, “Readable Font” item. The computing system identifies all elements, visible or not, within the same group of features (operation 710).

If the website user inputs a command to reset the group, the computing system is configured to deselect all elements of the group. In the context of a list of user interface elements, a “deselect all” or “clear selection” command that is received for a list comprising multiple different types of user interface elements may result in clearing selections from all user interface elements, regardless of whether the interaction is defined for that particular type. The list of user interface elements may thus be reset and similarly, the elements of the feature group may be reset.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing computer-executable instructions that, when executed by the processor, are to cause the processor to:
identify, in a graphical user interface, a first user interface element and a second user interface element, the first and second user interface elements being of different types and associated with a first group of user interface elements;
receive, via a keyboard, input of a command to trigger a first interaction with both the first and second user interface elements;
in response to receiving the input:
determine that the first interaction is not defined for one of the first and second user interface elements; and
perform a related action associated with the first interaction to the one of the first and second user interface elements.

2. The computing system of claim 1, wherein the first and second user interface elements are input controls corresponding to items of a defined set.

3. The computing system of claim 1, wherein each of the first and second user interface elements comprises one of a radio button or a checkbox.

4. The computing system of claim 1, wherein the first interaction comprises a deselect action for clearing selected items and wherein the related action comprises a clear action for cancelling selection from a radio button.

5. The computing system of claim 1, wherein performing the related action comprises determining the related action based on a mapping between user interface interactions and one or more related actions.

6. The computing system of claim 1, wherein identifying the first and second user interface elements comprises identifying user interface elements that are contained in a same defined region of the graphical user interface.

7. The computing system of claim 1, wherein performing the related action comprises modifying behavior of a defined second action that is applicable to the one of the first and second user interface elements.

8. A computer-implemented method, comprising:
identifying, in a graphical user interface, a first user interface element and a second user interface element, the first and second user interface elements being of different types and associated with a first group of user interface elements;
receiving, via a keyboard, input of a command to trigger a first interaction with both the first and second user interface elements;
in response to receiving the input:
determining that the first interaction is not defined for one of the first and second user interface elements; and
performing a related action associated with the first interaction to the one of the first and second user interface elements.

9. The method of claim 8, wherein the first and second user interface elements are input controls corresponding to items of a defined set.

10. The method of claim 8, wherein each of the first and second user interface elements comprises one of a radio button or a checkbox.

11. The method of claim 8, wherein the first interaction comprises a deselect action for clearing selected items and wherein the related action comprises a clear action for cancelling selection from a radio button.

12. The method of claim 8, wherein performing the related action comprises determining the related action based on a mapping between user interface interactions and one or more related actions.

13. The method of claim 8, wherein identifying the first and second user interface elements comprises identifying user interface elements that are contained in a same defined region of the graphical user interface.

14. The method of claim 8, wherein performing the related action comprises modifying behavior of a defined second action that is applicable to the one of the first and second user interface elements.

15. A non-transitory, computer-readable medium storing instructions thereon that, when executed by a processor, configure the processor to:
identify, in a graphical user interface, a first user interface element and a second user interface element, the first and second user interface elements being of different types and associated with a first group of user interface elements;
receive, via a keyboard, input of a command to trigger a first interaction with both the first and second user interface elements;
in response to receiving the input:
determine that the first interaction is not defined for one of the first and second user interface elements; and
perform a related action associated with the first interaction to the one of the first and second user interface elements.

16. The computer-readable medium of claim 15, wherein the first and second user interface elements are input controls corresponding to items of a defined set.

17. The computer-readable medium of claim 15, wherein each of the first and second user interface elements comprises one of a radio button or a checkbox.

18. The computer-readable medium of claim 15, wherein the first interaction comprises a deselect action for clearing selected items and wherein the related action comprises a clear action for cancelling selection from a radio button.

19. The computer-readable medium of claim 15, wherein performing the related action comprises determining the related action based on a mapping between user interface interactions and one or more related actions.

20. The computer-readable medium of claim 15, wherein identifying the first and second user interface elements comprises identifying user interface elements that are contained in a same defined region of the graphical user interface.
